(19) United States
(12) Patent Application Publication
(10) Pub. No.: US 2025/0328109 A1
(43) Pub. Date: Oct. 23, 2025

(54) TIMEPIECE COMPONENT MADE OF POLISHED TITANIUM ALLOY

(71) Applicant: ROLEX SA, Geneva (CH)

(72) Inventors: Loïc Favre, Geneva (CH); Daniele Mari, Bussigny (CH); Nicolas Vincent Barbi, Onex (CH); Denis Favez, Le Grand-Saconnex (CH)

(73) Assignee: ROLEX SA, Geneva (CH)

(21) Appl. No.: 18/861,914

(22) PCT Filed: May 5, 2023
(86) PCT No.: PCT/EP2023/061961

§ 371 Date: Oct. 31, 2024

(30) Foreign Application Priority Data
May 6, 2022 (EP) 22172027.9

(51) Int. Cl. G04B 37/22; A44C 27/00; C22F 1/18; G04D 3/00

(52) U.S. Cl. CPC G04B 37/22; A44C 27/003; C22F 1/183; G04D 3/0074

(57) ABSTRACT

The timepiece or jewellery component includes at least one part made of titanium alloy, one surface of which is polished. In some embodiments, the arithmetic mean roughness Ra of the polished surface can be less than 15 nm, even less than 12 nm, even less than 10 nm, and/or the mean total roughness Rz of the polished surface can be less than 90 nm, or even less than 80 nm, or even less than 60 nm. In some embodiments, the titanium alloy contains grains, notably β phase grains, and the difference between the mean height of the grains, notably of the β phase grains, of the polished titanium alloy surface is less than 150 nm, or even less than 120 nm, or even less than 100 nm.

### INTRODUCTION

The invention concerns a timepiece or jewelry component comprising at least one part based on an alloy of titanium. It also concerns a timepiece as such including such a timepiece component. It finally also concerns a method of manufacturing such a timepiece or jewelry component.

### BACKGROUND ART

The choice of materials, notably of metals or metal alloys, is very important in the design of a timepiece component. In fact, a metal or metal alloy must for example achieve the best possible compromise between numerous constraints, including:
An attractive appearance, free of visible defects. To this end a noble metal is often chosen, with a very careful surface finish, to be attractive.
Particular mechanical properties, particularly high specific resistances, such as good resistance to fatigue and excellent resistance to corrosion, and good shapeability. Additionally, it is also wished to obtain a sufficient hardness to minimize the risks of the surface state being degraded over time.
A low density is beneficial for minimizing the overall weight of a timepiece.

Of the alloys addressing those constraints, titanium alloys are of interest because they have a much lower density than other alloys, notably steel, while having mechanical properties of global interest. However, the titanium alloys used have the disadvantage of having by nature a mediocre aptitude for polishing, resulting in an irregular surface state with defects. To prevent the presence of polishing defects on existing titanium alloy surfaces the choice is generally made to apply a satin or sand-blasted finish, which therefore limits the possible surface appearances of such a component.

One object of the invention is to define a solution enabling wider use of a titanium alloy in a timepiece or jewelry component, not limited to the possibilities defined by the prior art.

### SUMMARY OF THE INVENTION

To this end the invention is based on a timepiece or jewelry component characterized in that it comprises at least one part made of titanium alloy one surface of which titanium alloy is polished.

The invention is precisely defined by the claims.

### BRIEF DESCRIPTION OF THE DRAWINGS

These objects, features and advantages of the present invention will be described in detail in the following non-limiting description of one particular embodiment with reference to the appended figures, in which:

FIG. 1 depicts a first view of the surface of a titanium alloy portion that is obtained by polishing a prior art titanium alloy.

FIG. 2 depicts a second view of the surface of a titanium alloy portion that is obtained by polishing another prior art titanium alloy.

FIG. 3 represents schematically the steps of the method in accordance with one embodiment of the invention of manufacturing a titanium alloy component.

FIG. 4 represents schematically the first two steps of the method in accordance with the preferred embodiment of the invention of manufacturing the titanium alloy component.

FIG. 5 represents schematically the last two steps of the method in accordance with the preferred embodiment of the invention of manufacturing the titanium alloy component.

FIG. 6 represents an example of mechanical spectroscopy measurements used by this embodiment of the invention.

FIG. 7 depicts a view of the surface of a titanium alloy portion that is obtained by polishing a titanium alloy in accordance with the invention.

FIG. 8 represents measurements of HV0.2 hardness as a function of the annealing time obtained on samples of Ti-※titanium alloy respectively obtained using a method in accordance with one embodiment of the invention (steps 1-4) and in accordance with an alternative method (steps 1-2+4, without step 3).

FIG. 9 represents measurements of roughness Rx in accordance with standardized parameters Rt, Rz and Ra obtained from samples of Ti-5553 titanium alloy respectively obtained using a method in accordance with one embodiment of the invention (steps 1-4) and two alternative methods (respectively with steps 1-2+4, without step 3, and with steps 1-2, without steps 3-4).

FIG. 10 is an observation of a Ti-4733 titanium alloy obtained using a transmission electron microscope (TEM) and a method in accordance with one embodiment of the invention (steps 1-4).

FIG. 11 is an observation of a Ti-4733 titanium alloy obtained using a transmission electron microscope (TEM) and using an alternative method (steps 1-2+4).

FIG. 12 is an observation of a Ti-4733 titanium alloy obtained using a transmission electron microscope (SEM) and using a method in accordance with one embodiment of the invention (steps 1-4).

FIG. 13 is an observation of a Ti-4733 titanium alloy obtained using a scanning electron microscope (SEM) and using an alternative method (steps 1-2+4).

### DETAILED DESCRIPTION OF PARTICULAR EMBODIMENTS

Throughout the document the expression “based on an alloy” will be used for any part comprising at least 50% by weight of the alloy concerned.

The invention relates to a timepiece or jewelry component that comprises at least one part made of titanium alloy or based on titanium alloy in which the titanium alloy extends over at least a part of a visible surface of said component. The invention will define a method making it possible to obtain a titanium alloy with new properties compatible with obtaining a surface state of attractive esthetic appearance, in particular enabling a polished surface to be obtained conveniently, ideally of a quality similar to a polished surface as obtained for example with another alloy, notably a steel.

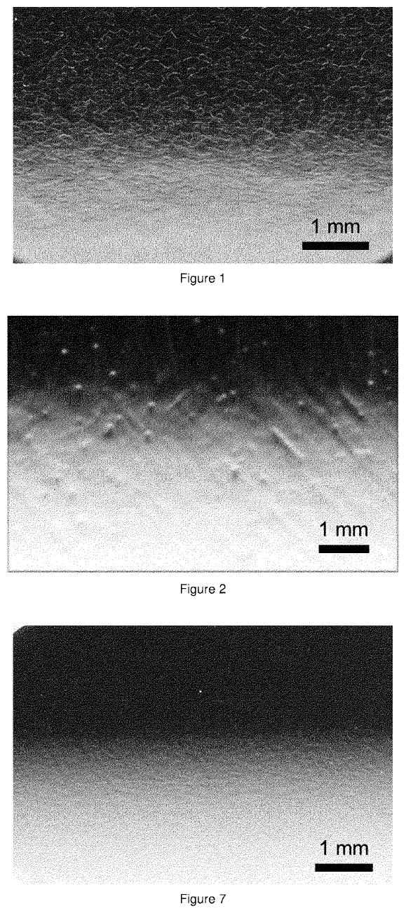

According to the invention it is found that the prior art titanium alloys used for timepiece applications have a two-phase form, comprising an α phase and a β phase. The a phase corresponds to a hexagonal crystalline structure and the β phase corresponds to a centered cubic crystalline structure. The mechanical property differences between the two phases create problems when finishing a titanium alloy surface, which still has a β phase grain microstructure that remains visible after attempted polishing, resulting in an “orange peel” appearance, as depicted in FIG. 1, and/or with an abrasive embedded in the ductile β phase that causes scratches and defects as depicted in FIG. 2. FIGS. 1, 2 and 7 are produced by imaging the reflection of a pattern on the titanium alloy surface comprising a black zone and a white zone, which makes it possible to show the polishing defects.

Because of this it is at present impossible to obtain a polished finish on a titanium alloy surface that is satisfactory from the point of view of the high requirements for timepieces and jewelry. This difficulty is particularly apparent on extended surfaces (for example the surface of a watch case, a bracelet link part, or a clasp). This limits the application of titanium alloys to satin-finish or sand-blasted surfaces. The result of this is that at present there exists no method for polishing a surface of a timepiece or jewelry component made of titanium alloy and no efficient method of manufacture employing finishing of a timepiece or jewelry component comprising a polishing step. Thus there does not either exist any wristwatch having over most or even the whole of its visible surface this kind of polished titanium alloy surface. This represents a severe limitation on the use of titanium alloys in timepieces and jewelry.

The invention is therefore based on a method of manufacturing all or part of a component made of titanium alloy or based on titanium alloy that notably makes it possible to use a step of polishing a surface made of titanium alloy or based on titanium alloy of said component in a manner compatible with the high requirements for timepieces and jewelry.

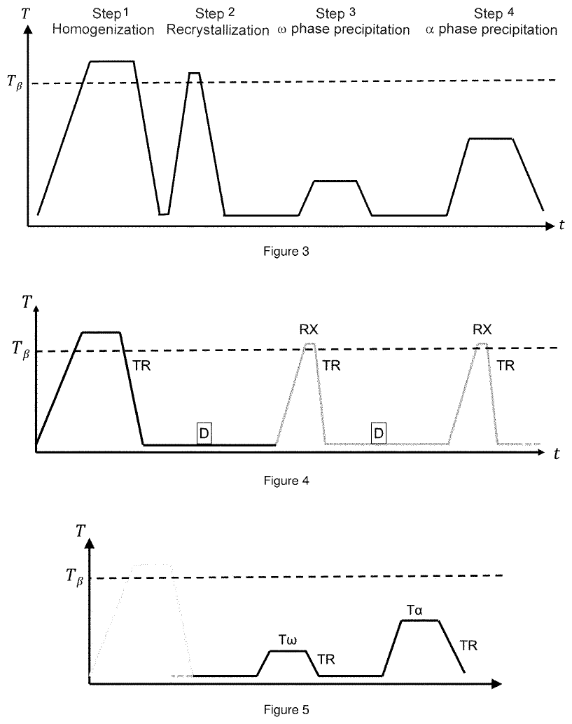

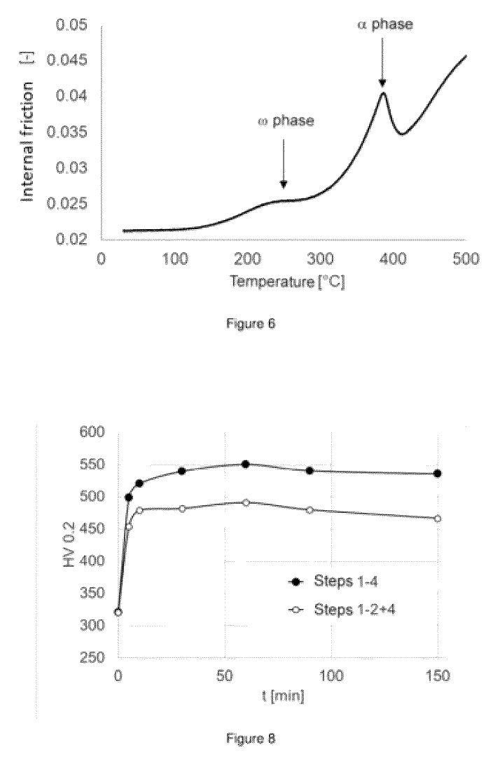

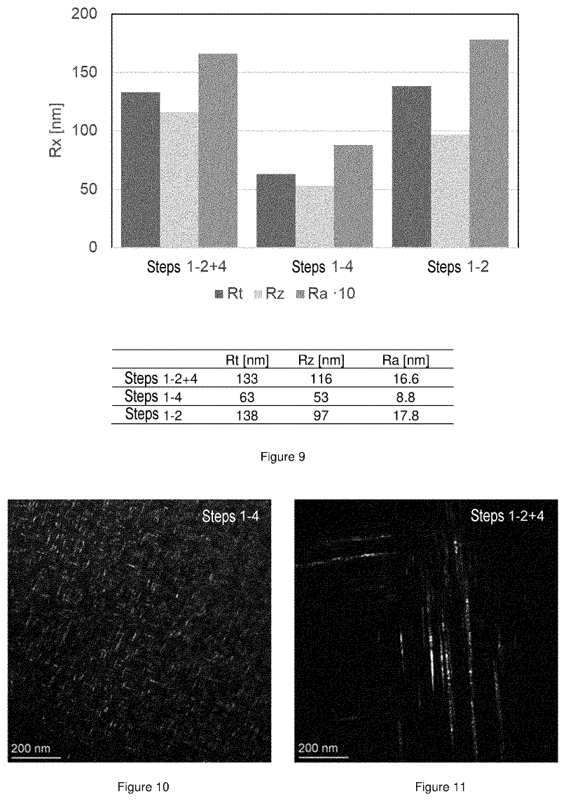

In one embodiment of the invention the method of manufacture is based on a thermomechanical treatment that comprises the following steps, schematically depicted in FIG. 3:
heat treatment of the titanium alloy at a temperature higher than the transition temperature Tβ from the α phase to the β0 phase followed by cooling to obtain a structure substantially comprising only β phase grains (step 1, homogenization),
a succession of cycles of deformation or at least one cycle of deformation, notably of cold deformation, and recrystallisation heat treatment at a temperature slightly higher than the transition temperature from the α phase to the β phase to preserve a structure comprising substantially only β phase grains while reducing the dimension of the β phase grains (step 2),
nucleation or precipitation of a metastable w phase by heat treatment at low temperature (step 3),
precipitation of an α phase by heat treatment at an intermediate temperature, higher than the low temperature of said nucleation of an ω phase and lower than the transition temperature from the α phase to the β phase, to obtain the growth (or precipitation) of the α phase that will harden said titanium alloy (step 4). In other words, this nucleation of an ω phase serves to seed precipitation of the α phase.

FIG. 4 represents schematically the implementation of the first two steps of the method according to one particularly advantageous embodiment.

The first, heat treatment step is advantageously effected at a temperature between 0 and 100° C., preferably between 10 and 50° C., above the transition temperature Tβ from the α phase to the β phase, and preferably under a protective atmosphere. This first step makes it possible to obtain a microstructure of the titanium alloy consisting entirely of the β phase. Cooling by quenching TR makes it possible to fix the β phase at ambient temperature. The processing time t is relatively short, ideally 30 minutes or less, in order to limit the growth of the grains of the β phase and to have the smallest possible grain size. This step also enables homogenization of the titanium alloy.

In other words, this first, homogenization step makes it possible to dissolve the α phase that may be present in the material. The rapid cooling from the entirely β phase structure makes it possible to fix that structure at ambient temperature in alloys not forming a martensitic phase. The entirely β phase structure is sufficiently ductile for effecting the subsequent deformation steps that will enable recrystallization.

In this embodiment the second step in the succession of deformation cycles comprises a succession of cycles D of cold deformation and recrystallization heat treatments RX. The object of this step is to obtain a microstructure that still comprises a maximum of, ideally 100% of, β phase, and thus with a minimum of, ideally no, α phase and with the smallest possible grain size. In fact it is very difficult to deform the material in the presence of the α phase, which is the hardest and will induce cracks during deformation. It is therefore very difficult to reduce the size of the β phase grains in the presence of the α phase. The approach chosen overcomes this difficulty by acting on the alloy composed entirely of the β phase. Naturally, the method could be carried out in the presence of a small quantity of the α phase, preferably less than 10% by volume. The heat treatment advantageously leads to brief exposure of the titanium alloy to a temperature slightly higher than Tβ followed by immediate quenching TR. This temperature may be between Tβ and Tα+20° C. inclusive. The duration is preferably between 3 min and 10 min inclusive for typical dimensions of timepiece external parts but must be adapted to suit the dimensions of the parts treated. It is possible to perform several cycles in succession to refine the grains. Alternatively, a single cycle could suffice. Between 2 and 10 cycles, even between 2 and 5 cycles, are advantageously carried out.

In this second step the deformation of the titanium alloy part introduces dislocations in the alloy that induce recrystallization in the form of finer grains during the heat treatment. Cold deformation, such as rolling at ambient temperature or cold forging is of benefit for this deformation. These cold deformation methods are advantageous because they are easy to control. Nonetheless, it is instead possible to use a hot deformation method, such as forging or uniaxial deformation at high temperature. To summarize, the function of this second step is therefore to reduce as much as possible the size of the microstructure, to be more precise of the β phase grains.

FIG. 5 represents schematically the last two steps of the method according to one particularly advantageous embodiment.

The third step of nucleation of an w phase advantageously comprises heat treatment Tω at a temperature between 150° C. and 350° C. inclusive for less than 4 h, and notably a temperature between 250° C. and 330° C. inclusive for between 2 h and 4 h inclusive. This step of heat treatment at low temperature causes nucleation of the metastable ω phase that will appear homogeneously in the titanium alloy. The benefit stems from the fact this ω phase will serve as a seeding site for future growth of an α phase.

In fact, the fourth step, the precipitation of the α phase, comprises a heat treatment Tα carried out at a temperature between 350° C. and 650° C. inclusive for between 1 h and 3 h inclusive, even between 500° C. and 600° C. inclusive and between 1 h and 3 h inclusive. This step makes it possible to cause a final α phase to appear in the titanium alloy. This growth (precipitation) of an α phase by seeding an ω phase has the advantage of obtaining homogeneous and fine distribution (ideally on a submicron scale, even between 1 and 10 μm for the greatest dimension) of the α phase in the alloy. Thus the resulting structure is advantageously not a lamellar structure. Furthermore, the precipitation at the grain boundaries, even if it may occur, does not constitute a major part of the α phase.

Note that the third step has been described as a separate, independent step. Alternatively it could be included in ramping up the temperature in the fourth step, that is to say correspond to a sub-step of that fourth step.

The method described above makes it possible to obtain an alloy best combining the two phases α and β, each of which contributes its advantages to the alloy without the drawbacks of the prior art.

In fact, the α phase makes it possible to achieve a satisfactory hardness of the alloy that would be too soft with only the β phase. The good distribution of the α phase and its nanometric dimension thus favor obtaining this optimum hardness of the alloy. The minimum hardness is important so as to be able to employ a polishing step that would cause the surface to deteriorate if the material were too soft. The hardness naturally also favors the maintaining of the quality of the surface state over time. To illustrate these properties FIG. 8 represents an example of HV0.2 hardness measurements obtained on samples of Ti-5553 titanium alloy obtained using a method in accordance with one embodiment of the invention (steps 1-4) and an alternative method (steps 1-2+4, without step 3), as a function of the annealing time t at a temperature of 550° C. in step 4. There is a large and significant difference of more than 50 HV between the samples according to this embodiment of the invention and the samples without using step 3 of the method in accordance with this embodiment of the invention for the same annealing time. Generally speaking, the precipitation of the very fine α phase induced by the method in accordance with the invention makes it possible to increase the typical hardness of 50 HV relative to an alternative method. Consequently, the precipitation of the very fine α phase induced by the method in accordance with the invention makes it possible to increase the hardness above 450 HV, even above 500 HV, depending on the titanium alloy concerned and the hardness obtained by an alternative method. By way of comparison, a titanium alloy with no α phase has a hardness below 300 HV: by way of example, measurements effected on a sample obtained using an alternative method, not represented, with only steps 1-2 and corresponding to a sample quenched from the β phase with no formation of the α phase, show a hardness of 291 HV0.2. A prior art titanium alloy that comprises the two phases α and β has a hardness below 400 HV. The homogeneous distribution of grains of the α phase also makes it possible to prevent the carbide particles used for polishing becoming embedded in the alloy and degrading the surface, as depicted in FIG. 2. The proportion of the α phase is advantageously between 35% and 55% by volume inclusive, even between 35% and 65% by volume inclusive.

The β phase is decisive for the reflectivity of the surface. Grains of the β phase of large size can for example have varying reflectivities that compromise the resulting surface visual appearance. In fact, if these β phase grains are too large they form irregularities visible to the naked eye on the surface during a step of polishing the surface. The method makes it possible to minimize the size of the β phase grains. Furthermore, the method enables homogenization of the distribution of the α phase in the β phase grains.

Finally, this resulting structure of the titanium alloy makes it possible to form a polished surface of high quality using conventional polishing techniques, as depicted in FIG. 7.

As explained above, the various steps of the method are carried out under certain temperature conditions chosen to control the structure of the titanium alloy. Note that these temperature values depend on the composition of the titanium alloy used. It is therefore not the optimum to predefine fixed temperature values but it is advantageous to choose appropriate temperatures for each alloy in order to employ the method in accordance with this embodiment in an optimized manner.

The method in accordance with this embodiment of the invention therefore comprises one or more sub-steps of determination of the optimized temperatures to be considered, notably the transition temperatures, like the seeding of the ω phase and the α phase and the recrystallization temperature.

To this end one advantageous embodiment is based on the use of mechanical spectroscopy or internal friction. The measurement of the internal friction makes it possible to measure the energy dissipation linked to the movements of defects, such as dislocations, grain boundaries or localized defects in the microstructure. If the mobility of these defects depends on temperature it is possible to detect the temperatures at which said defects begin to move in the alloy. Given that the nucleation and the recrystallization phases both require transformation of the microstructure, it is possible to detect the temperatures at which they occur using mechanical spectroscopy. As represented by way of example in FIG. 6 for a non-deformed sample of Ti-4733 titanium alloy, the internal friction curve as a function of temperature makes it possible to identify the phenomena of nucleation of the phases and/or of recrystallization of the alloy. The various structure changes that are noteworthy and used in the method in accordance with this embodiment of the invention correspond to different peaks or shoulders of the curve. For example, this curve makes it possible to determine the temperature enabling nucleation of the ω phase and the α phase, which respectively appear as a shoulder and a peak in FIG. 6. The position of the various peaks is for example obtained by deconvolution. To be more precise, deconvolution of the mechanical spectroscopy measurement can be carried out with a constant base line, a bottom that varies in accordance with an exponential function of temperature and an Arrhenius type function applied to at least one peak, finally to extract the temperature. Thus by measuring internal friction phenomena in the alloy by mechanical spectroscopy it is possible to define precisely the temperatures associated with the various phenomena used in the various steps of the invention.

In particular, the nucleation of the w phase in the titanium alloy is detectable by mechanical spectroscopy whereas this w phase is very difficult to identify by other methods. Furthermore, mechanical spectroscopy has the advantage that it can be used in real time, enabling “in situ” observation of the alloy.

Work carried out by the inventors therefore shows that mechanical spectroscopy is a suitable technique for the identification of the transition temperatures in titanium alloys, which to their knowledge has not been considered up until now. Surprisingly, it is possible to identify seeding peaks in the titanium alloys which enables practical use of the method in accordance with the invention and obtaining the titanium alloy component in accordance with the invention. More generally, for any titanium alloy having a type α+β microstructure at the temperature of use it is advantageous to employ a step of determination by mechanical spectroscopy of the transition temperature and/or the recrystallization temperature of said titanium alloy, notably to determine the temperature of said nucleation of the ω phase, even the nucleation of the α phase, even the recrystallization temperature. This optimized embodiment of the method in accordance with the invention enables a first effect to be obtained consisting in a maximum surface hardness, as depicted in FIG. 8.

Alternatively, the nucleation of an ω phase may be shown by transmission electronic microscopy, in particular by electronic diffraction that shows the appearance of the unique signature of the crystalline structure of the w phase. Another technique that may be used is measurement of the electrical resistance, which varies slightly when the w phase is precipitated. These other detection techniques are methods that are more complex to implement and/or less precise.

Finally, mechanical spectroscopy measurement makes it easy to optimize the duration and the temperature of the treatments for each given alloy and for each step of the method in accordance with this embodiment of the invention. Note that the duration and temperature values remain comparable from one alloy to another for certain steps of the method.

The table below illustrates a few total or partial test implementations of the method with a few titanium alloys. This table shows first the important effect of the third step of the method. In fact, a few tests carried out with this third step eliminated give poor results, more exactly a surface that no longer reacts in a satisfactory manner to a polishing step. To the contrary, use of the invention as described above enables a very good result to be achieved, notably very good polishing.

| | Homogenization | ω precipitation | α precipitation | |
|---|---|---|---|---|
| | (step 1) | (step 3) | (step 4) | Polishability |
| Ti-4733 | 900° C., | No step 3 | 550° C., 1 h | − |
| without step 3 | water quench | | | |
| Ti-4733 | 900° C., | 300° C., 1 h | 550° C., 1 h | ++ |
| with step 3 | water quench | | | |
| Ti-5553 | 900° C., | No step 3 | 550° C., 1 h | − |
| without step 3 | water quench | | 550° C., 3 h | |
| Ti-5553 | 900° C., | 300° C., 1 h | 550° C., 1 h | ++ |
| with step 3 | water quench | 350° C., 3 h | 600° C., 1 h | |
| Ti-15-3, | 900° C., | No step 3 | 550° C., 1 h | − |
| Ti—15.9V—3Cr—3.6Al—3Sn | water quench | | | |
| without step 3 | | | | |
| Ti-15-3, | 900° C., | 300° C., 1 h | 550° C., 1 h | − |
| Ti—15.9V—3Cr—3.6Al—3Sn | water quench | 350° C., 3 h | | |
| with step 3 | | | | |

FIG. 9 represents Rt, Rz and Ra roughness measurements (the values of Ra being multiplied by 10 in the bar chart) obtained from samples of Ti-5553 alloy respectively obtained using a method in accordance with one embodiment of the invention (steps 1-4) and two alternative methods (respectively using only steps 1-2+4, without step 3, and using only steps 1-2, without steps 3 and 4). The three roughness parameters considered are measured and calculated in accordance with the ISO 21920 standard, with Rt, termed the total height: the distance between the deepest point and the highest point of all the profiles considered, Rz, termed the maximum height: the mean value over all of the profiles of the maximum distance between the deepest point and the highest point, and Ra, termed the arithmetic mean height, the length of the profiles concerned being 0.8 mm. The sample used in the alternative method (“steps 1-2”) corresponds to a sample quenched from the β phase, with no formation of the α phase and with a low hardness less than 300 HV0.2. The sample used in another alternative method (“steps 1-2+4”) corresponds to a quenched sample of the β phase then subjected to annealing at a high temperature of 550° C., with an α phase precipitated in the β phase grains at the grain boundaries, which is a clear increase in hardness. The sample in accordance with the invention (“steps 1-4”) correspond to a sample quenched from the β phase and then subjected to a first annealing at a moderate temperature of 290° C. to precipitate the ω phase and a second annealing at a high temperature of 550° C. to form the a phase in the β grains, and shows the highest hardness. For the three roughness parameters considered, the roughness is much less in samples in accordance with the invention compared to samples obtained using the alternative methods. Thus optimized use of the method in accordance with the invention makes it possible to obtain as a second effect a minimum surface roughness.

To be more precise, when the third step of the method is omitted a microstructure is obtained with a maximum height difference measured between the various β phase grains over a polished surface of approximately 100 nm (measured zone typically 1.5×1.5 mm²), as the measurement of the roughness parameter Rz indicates; polishability is therefore judged as very average by a specialist, as manifested by visible “orange peel” zones. When the third step is used the α phase zones are of very small size and a hardness of 472 HV is achieved. Furthermore, the maximum difference between the measured mean height of the various β phase grains over a polished surface is approximately 50 nm, as the measurement of the roughness parameter Rz indicates, that is a division by two of the height difference obtained without using the third step, which therefore enables a significant improvement in the polishability of the surface, in particular a satisfactory polished appearance, notably no orange peel effect and no embedded abrasive particles.

FIG. 10 depicts an observation of a Ti-4733 titanium alloy sample obtained by a method in accordance with the invention using dark field transmission electron microscopy (TEM) with the sample aligned on a <110> zone axis, selecting one of the beams diffracted by the α phase. The sample obtained by an alternative method (steps 1-2+4), represented in FIG. 11, with a step 4 carried out a low temperature in the recommended range (390° C. for 1 h) shows very extensive growth of a grains in a given preferred direction with a very non-homogeneous distribution. Thus if the seeding and growth heat treatment of the α phase is carried out in a single step the α phase is very non-homogeneous with very elongate grains, with more than 500 nm in length as their greatest dimension, as in FIG. 11. The sample in accordance with the invention (steps 1-4) with a step of seeding of the ω phase at 240° C. for 1 h before the annealing in step 4 at 390° C. for 1 h shows very fine a phase grains dispersed in a homogeneous manner. Note that TEM observations produced after step 3 and before step 4 show the presence of the ω phase and no presence of the α phase.

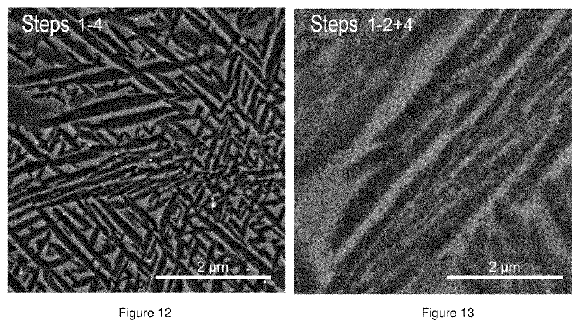

FIG. 12 depicts an observation of a Ti-4733 titanium alloy sample obtained by a method in accordance with the invention using a scanning electron microscope (SEM). The sample obtained by an alternative method (steps 1-2+4) represented in FIG. 13 with a step 4 carried out at a temperature of 600° C. again shows very extensive growth of a grains with a very non-homogeneous distribution. This sample may be seen as the logical outcome of the FIG. 11 sample, the higher temperature in step 4 favoring the growth of the α phase. The sample in accordance with the invention (steps 1-4), with an ω phase seeding step at 240° C. for 1 h before annealing in step 4 at 600° C. shows clearly much finer and homogenously dispersed α phase grains. These TEM and SEM observations clearly show the importance of the ω phase (and therefore of step 3 in accordance with the invention) for obtaining an α phase with very fine grains dispersed homogeneously.

The table hereinabove also indicates that some alloys, such as Ti-4733 and Ti-5553, are particularly suitable for obtaining a satisfactory polished appearance. Other alloys, such as Ti-15-3 or Ti-15.9V-3Cr-3.6Al-3Sn, are less suitable.

The table hereinabove also indicates various conditions for certain steps that yield an equivalent result. It is therefore seen that, for the third step of the method, conditions (temperature, time) between (300° C., 1 h) and (350° C., 3 h) have been successfully tested.

More generally, the time and temperature parameters of the method are interchangeable to some extent and a higher temperature applied for a shorter time may for example give a result comparable to a lower temperature applied for a longer time. Thus the person skilled in the art will find favorable conditions by choosing temperature/time pairs from the following generalized ranges. To obtain the precipitation of the ω phase (third step of the method), a low temperature between 150° C. and 350° C. inclusive for a time of at most 4 h may be suitable, and a low temperature between 250° C. and 330° C. inclusive for a time between 2 h and 4 h inclusive may even be suitable. To obtain the precipitation of the α phase (fourth step of the method) the temperature/time pair may be fixed between (500° C., 1 h) and (600° C., 3 h). The above conditions can therefore be adjusted and are not to be considered as fixed and absolute limits.

There exist alternatives to steps 1 and 2 described hereinabove to obtain a microstructure formed of β phase grains of small size. It is notably possible to employ forging and hot deformation at a temperature below Tβ or at a temperature above Tβ. In this variant method α phase grains may already be present and the aim is to refine as much as possible the β phase grains by deformation. Steps 3 and 4, notably step 3 of seeding of the ω phase remain unchanged. In another variant the ω phase seeding step 3 may also comprise forging and deformation to combine mechanical refining of the grains with the formation of very fine ω grains dispersed homogenously.

Finally, the invention also consists in a method of manufacturing a timepiece or jewelry component characterized in that it comprises a finishing step of polishing a titanium alloy surface of the component.

The embodiment of the method of manufacture can be implemented with any titanium alloy. However, note that certain titanium alloys have a more favorable structure than others, which makes it possible to obtain an optimum result, particularly in terms of polishability. In order to enable use of the method in accordance with the invention these alloys comprise alloy elements that stabilize the β phase at ambient temperature. By way of example, the Ti-5553 or Ti-4733 alloy, even the Ti-5553 or Ti-4733 or Ti-10-2-3 or Beta-C or VT22 or Ti-1-8-5 or Ti-8823 alloy, even the Ti-5553 or Ti-4733 or Ti-10-2-3 or Beta-C or VT22 or Ti-1-8-5 or Ti-8823 or Beta21S or Timetal21S or Betalll or TMA alloy, yield very good results.

More generally, it appears that a titanium alloy that conforms to the range 8≤MoE≤11, even 8.3≤MoE≤10.0, where MoE is the molybdenum equivalent, reacts particularly well during execution of the method in accordance with this embodiment of the invention. The molybdenum equivalent (MoE) takes account of the stabilizing effect for the β phase of the various elements by weighting it using the formula MoE=1.0 (wt % Mo)+0.67 (wt % V)+0.44 (wt % W)+0.28 (wt % Nb)+0.22 (wt % Ta)+2.86 (wt % Fe)+1.67 (wt % Cr)+1.25 (wt % Ni)+1.70 (wt % Mn)+1.70 (wt % Co)+0.77 (wt % Cu)+0.78 (wt % Sn)−0.17 (wt % Zr)−1.0 (wt % Al).

Additionally or alternatively a titanium alloy may be characterized by the parameters Bo and Md that are respectively the bond order and the mean d-orbital energy level defined by Morinaga (cf. M. Morinaga, The molecular orbital approach and its application to biomedical titanium alloy design, in Titanium in Medical and Dental Applications, FH Froes and M. Qian eds, Woodhead Publishing, 2018) and calculated using the following formulas: Md=2.447 (at % Ti)+1.961 (at % Mo)+1.872 (at % V)+2.072 (at % W)+2.424 (at % Nb)+2.531 (at % Ta)+0.969 (at % Fe)+1.478 (at % Cr)+0.724 (at % Ni)+1.194 (at % Mn)+0.807 (at % Co)+0.567 (at % Cu)+2.100 (at % Sn)+2.934 (at % Zr)+2.200 (at % Al); Bo=2.79 (at % Ti)+3.063 (at % Mo)+2.805 (at % V)+3.125 (at % W)+3.099 (at % Nb)+3.144 (at % Ta)+2.651 (at % Fe)+2.779 (at % Cr)+2.412 (at % Ni)+2.723 (at % Mn)+2.529 (at % Co)+2.114 (at % Cu)+2.283 (at % Sn)+3.086 (at % Zr)+2.426 (at % Al). It therefore appears that a titanium alloy that complies with the ranges 2.755<Bo<2.810 and 2.33<Md<2.44, even 2.758<Bo<2.788 and 2.330<Md<2.385, even 2.765<Bo<2.775 and 2.36<Md<2.38, responds particularly well during the implementation of the method according to this embodiment of the invention.

| Alloy | Composition | MoE | Md | Bo |
|---|---|---|---|---|
| Ti-5553 | Ti—5Al—5Mo—5V—3Cr | 8.3 | 2.360 | 2.765 |
| Ti-4733 | Ti—4Al—7Mo—3Cr—3V | 10.0 | 2.369 | 2.774 |
| Ti-10-2-3 | Ti—10V—2Fe—3Al | 9.4 | 2.356 | 2.770 |
| Beta C; | Ti—3Al—8V—6Cr—4Zr—4Mo | 15.7 | 2.335 | 2.783 |
| Ti-3864 | | | | |
| VT22 | Ti—5.7Al—5.1V—4.8Mo—1Cr—1Fe | 7.0 | 2.362 | 2.760 |
| Ti-1-8-5 | Ti—1Al—8V—5Fe | 18.6 | 2.336 | 2.779 |
| Ti-8823 | Ti—8V—8Mo—2Fe—3Al | 16.0 | 2.343 | 2.780 |
| Beta21S | Ti—15Mo—3Nb—3Al | 12.8 | 2.394 | 2.796 |
| Timetal | Ti—15Mo—2.7Nb—3Al—0.2Si | 12.8 | 2.394 | 2.796 |
| 21S | | | | |
| BetaIII | Ti—11.5Mo—6Zr—4.65Sn | 14.1 | 2.425 | 2.807 |
| TMA | Ti—11.5Mo—6Zr—4.5Sn | 14.0 | 2.426 | 2.808 |
| | Ti—15.9V—3Cr—3.6Al—3Sn | 14.3 | 2.314 | 2.763 |
| Ti15-3 | Ti—15V—3Cr—3Sn—3Al | 14.3 | 2.321 | 2.766 |

The method in accordance with the invention makes it possible to obtain both a high hardness and a fine microstructure, and therefore good polishability and low roughness after polishing. The seeding and the growth of the α phase are controlled by two annealing steps (steps 3 and 4), preferably on the basis of a small β phase grain microstructure. The size of the β phase grains is determined by the recrystallization and deformation steps and the size of the α phase grains by the seeding of the ω phase in an initial time (annealing in step 3) and then by additional annealing in a second time (step 4). Characterization of the alloy by mechanical spectroscopy makes it possible to identify the temperature and the duration of the various annealing steps. The controlled growth of the ω phase induces a presence of ω phase grains of very small size distributed homogeneously, without the simultaneous growth or seeding of the α phase. Consequently, the α phase that is seeded and grows during subsequent annealing is also extremely fine and homogeneous, as the FIGS. 10 and 12 observations show.

The invention also relates to a timepiece or jewelry component as such characterized in that it comprises at least one part made of titanium alloy or based on titanium alloy where a surface of that titanium alloy is polished. In fact, as discussed above, the invention enables manufacture of such a titanium alloy so as to render it notably compatible with polishing with the high requirements of the timepiece and jewelry fields.

This polishing may for example be defined by the difference between the mean heights of the β phase grains of the polished titanium alloy surface, which may be less than 150 nm, even less than 120 nm, even less than 100 nm. Additionally or alternatively this polishing may also be defined by the roughness parameter Rz corresponding to the maximum distance between the deepest point and the highest point observed over all of the profiles measured, which can be less than 90 nm, even less than 80 nm, even less than 60 nm. Additionally or alternatively this polishing may be defined by the roughness parameter Ra defined by the standard mentioned above, the value of which is less than 15 nm, even less than 12 nm, even less than 10 nm. The invention is not limited to polishing defined by this precise value of the roughness.

In other words, the timepiece or jewelry component in accordance with the invention may comprise at least one part made of titanium alloy comprising grains, notably β phase grains, where a surface of that titanium alloy is polished, characterized in that the difference between the mean heights of the grains, notably of the β phase grains, of said titanium alloy polished surface is less than 150 nm and/or in that the mean total roughness Rz of said polished surface is less than 90 nm and/or in that the arithmetic mean roughness Ra of said polished surface is less than 15 nm; even in that the difference between the mean heights of the grains, notably of the β phase grains, of said polished titanium alloy surface is less than 120 nm and/or in that the mean total roughness Rz of said polished surface is less than 80 nm and/or in that the arithmetic mean roughness Ra of said polished surface is less than 12 nm; even in that the difference between the mean height of the grains, notably the β phase grains, of said polished titanium alloy surface is less than 100 nm and/or in that the mean total roughness Rz of said polished surface is less than 60 nm and/or in that the arithmetic mean roughness Ra of said polished surface is less than 10 nm.

The titanium alloy of the component may advantageously be chosen from the list given hereinabove. More generally, the titanium alloy obtained achieves a very good compromise between all of the constraints referred to at the beginning of the document. In addition to its polishability, it is hard, strong and light in weight.

The titanium alloy of the invention advantageously comprises β phase grains with a mean dimension less than or equal to 50 μm, even less than or equal to 45 μm or 40 μm. This dimension may optionally be less than or greater than or equal to 25 μm, even greater than or equal to 35 μm.

The titanium alloy advantageously comprises the a phase homogeneously distributed in the β phase grains.

The component also comprises a titanium alloy that advantageously has a hardness greater than or equal to 400 HV, even greater than or equal to 450 HV, even greater than or equal to 470 HV. This hardness may be between 400 and 600 HV inclusive, even between 450 HV and 550 HV inclusive, even between 470 HV and 500 HV inclusive.

The invention applies to a timepiece or jewelry component entirely composed of titanium alloy as defined above. Alternatively, the component may comprise only a part made of such titanium alloy. Alternatively, it may be wholly or in part based on such titanium alloy. For example, in one example said titanium alloy occupies at least 75% of the volume of said component. In another example the component comprises at least one part including said polished surface, which is entirely made of said titanium alloy, and/or has a thickness greater than or equal to 0.1 mm, which is to say that the part is not a simple thin surface coating but forms a solid volume.

On the other hand, the timepiece component in accordance with the invention is advantageously an external part of a timepiece, in particular of a wristwatch, in particular a component of a wristwatch casing such as a watch case, a back, a bezel, a crown or a crown cover. It may also be a component of a bracelet or a clasp, such as a link part, an edge link part, a center link part, a link, a clasp blade, a clasp cover or a clasp link part.

The invention also relates to a timepiece, notably a wristwatch, characterized in that it comprises at least one timepiece component as defined above.

1. A timepiece or jewelry component,
wherein the timepiece or jewelry component comprises at least one part made of titanium alloy,
wherein a surface of the titanium alloy is polished.

2. The timepiece or jewelry component as claimed claim 1, wherein an arithmetic mean roughness Ra of the polished surface is less than 15 nm.

3. The timepiece or jewelry component as claimed in claim 1, wherein a mean total roughness Rz of the polished surface is less than 90 nm.

4. The timepiece or jewelry component as claimed in claim 1, wherein the titanium alloy contains grains and a difference between a mean height of the grains of the polished surface is less than 150 nm.

5. The timepiece or jewelry component as claimed in claim 1, wherein the titanium alloy conforms to a range 8≤MoE≤11, and/or a range 2.755<Bo<2.810 and 2.33<Md<2. 44, where MoE is a molybdenum equivalent, and Bo and Md respectively represent a bond order and a mean d-orbital energy level.

6. The timepiece or jewelry component as claimed in claim 1, wherein the titanium alloy includes β phase grains with a mean dimension less than or equal to 50μm.

7. The timepiece or jewelry component as claimed in claim 1, wherein the titanium alloy includes β phase grains and α phase grains, the α phase grains being distributed homogeneously in the β phase grains.

8. The timepiece or jewelry component as claimed in claim 1, wherein the titanium alloy comprises β phase grains and α phase grains, the amount of the α phase grains being in a range of from 35% to 55% by volume.

9. The timepiece or jewelry component as claimed in claim 1, wherein the titanium alloy comprises at least one alloy selected from the group consisting of Ti-5553, Ti-4733, Ti-10-2-3, Beta-C, VT22, Ti-1-8-5, Ti-8823, Beta21S, Timetal21S, BetaIII, and TMA.

10. The timepiece or jewelry component as claimed in claim 1, wherein the titanium alloy has a hardness greater than or equal to 400 HV.

11. The timepiece or jewelry component as claimed in claim 1, wherein:
the titanium alloy occupies at least 75% of a volume of the timepiece or jewelry component, and/or
the timepiece or jewelry component comprises at least one part including the polished surface made entirely of the titanium alloy with a thickness greater than or equal to 0.1 mm, and/or
the timepiece or jewelry component is made entirely of the titanium alloy.

12. The timepiece or jewelry component as claimed in claim 1, wherein the timepiece or jewelry component is an external part of a timepiece.

13. A timepiece wherein the timepiece comprises at least one timepiece component which is the timepiece or jewelry component as claimed in claim 1.

14. A method of manufacturing a timepiece or jewelry component, wherein the method comprises:
treating at least one part made of titanium alloy of the timepiece or jewelry component, wherein the treating comprises performing a thermomechanical treatment of the titanium alloy, wherein the thermomechanical treatment comprises performing nucleation of a metastable ω phase serving as a seed for precipitation of the α phase.

15. The method claimed in claim 14, wherein
the nucleation of a metastable ω phase comprises performing a heat treatment at a temperature in a range of from 150° C. to 350° C., and
the method then comprises precipitating the α phase by a heat treatment at a temperature higher than a temperature of the nucleation of an ω phase and lower than a transition temperature from the α phase to the β phase.

16. The method claimed in claim 14, wherein the thermomechanical treatment comprises:
preliminarily producing a microstructure of the titanium alloy comprising β phase grains with a mean dimension less than or equal 50 μm.

17. The method claimed in claim 16, wherein the preliminary producing of the microstructure comprises:
performing a heat treatment at a temperature higher than a transition temperature from the α phase to the β phase of the titanium alloy, and
performing a succession of cycles of deformation or at least one cycle of deformation and recrystallization heat treatment at a temperature slightly higher than a transition temperature from the α phase to the β phase of the titanium alloy.

18. The method claimed in claim 17, wherein the preliminary producing of the microstructure comprises:
performing a heat treatment at a temperature higher than the transition temperature from the α phase to the β phase, at a temperature in a range of from 10 to 100° C. higher than the transition temperature, followed by cooling, to obtain a structure comprising substantially only β phase grains,
performing a succession of deformation cycles or at least one deformation cycle comprising a recrystallisation heat treatment at a temperature at most 20° C. higher than the transition temperature from the α phase to the β phase, to preserve a structure comprising substantially only β phase grains while reducing the dimension of the β phase grains,
then producing the nucleation of the metastable ω phase by heat treatment at a low temperature in a range of from 150° C. to 350° C. for 4 h or less, and
then performing a precipitation of the α phase by heat treatment at an intermediate temperature higher than a temperature of the nucleation of an ω phase and lower than the transition temperature from the α phase to the β phase, in a range of from 350° C. to 650° C. for 1 h to 3 h, to precipitate the α phase so as to harden the titanium alloy.

19. The method claimed in claim 14, wherein the titanium alloy conforms to a range 8≤MoE≤11 and/or a range 2.755<Bo<2.810 and 2.33<Md<2.44, where MoE is a molybdenum equivalent, and Bo and Md respectively represent a bond order and a mean d-orbital energy level.

20. The method claimed in claim 14, wherein the method comprises:
determining by mechanical spectroscopy a transition temperature and/or a recrystallisation temperature of the titanium alloy.

21. The method claimed in claim 14, wherein all the cooling actions of the thermomechanical treatment are carried out by quenching.

22. The method of claimed in claim 14, wherein the method comprises:
finishing by polishing a titanium alloy surface of the component to obtain a polished surface having a total mean roughness Rz less than 90 μm, and/or an arithmetic mean roughness Ra less than 15 μm.
